(19) United States
(12) Patent Application Publication
(10) Pub. No.: US 2005/0288956 A1
(43) Pub. Date: Dec. 29, 2005

(54) Systems and methods for integrating business process documentation with work environments

(76) Inventor: Ewald Speicher, Saarbruecken (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/153,400

(22) Filed: Jun. 16, 2005

Related U.S. Application Data
(60) Provisional application No. 60/579,663, filed on Jun. 16, 2004.

(51) Int. Cl. G06Q 99/00; G06F 17/30; G06F 17/00

(52) U.S. Cl. 705/1; 705/7; 707/1; 715/764

(57) ABSTRACT

Methods, systems, and articles of manufacture are provided for establishing a working environment in which business process documentation is linked with resources for implementing activities associated with the documented business processes. A business process is identified. Resources associated with the business process are also identified. Documentation of the business process is generated and associated with the identified resources. Access to the business process documentation and the associated resources is provided in the working environment.

### CROSS REFERENCE TO RELATED APPLICATION

This application claims the benefit of priority to U.S. Provisional Patent Application No. 60/579,663, entitled “Process-Driven Design and Documentation of Application Systems and Tool Support of Corporate Work Processes,” filed Jun. 16, 2004, the disclosure of which is expressly incorporated herein by reference to its entirety.

### TECHNICAL FIELD

The present invention generally relates to information processing and management and, more particularly, to systems, methods, apparatus, and computer-readable media for integrating business process documentation with work environments. Further, the invention relates to computerized systems and methods for providing a work environment in which business process documentation may be linked with resources for implementing activities associated with the documented business processes.

### BACKGROUND

Business processes are essential to many enterprises. Indeed, the success of an enterprise is often tied to the success of its business processes. Business processes typically describe a coordinated series of functions and/or activities that aim to produce added value for a given enterprise.

Many enterprises employ various management and modelling systems to document essential business processes. In fact, these systems are often a prerequisite for complying with standard-related or statutory requirements, such as ISO 9001, KontraG, etc. Such systems aim to provide employees with insight into their areas of responsibility and access to information required for understanding the processes to which their work contributes.

While management and modelling systems provide documentation of business processes, these systems often function independent from other aspects of an employee's working environment (e.g., assessing applications, drawing-up offers, entering receipt of goods, familiarization with detailed work instructions, finding telephone numbers, sending mails, etc.). This is often true even when those aspects of the working environment are directly related to the documented business processes. The disconnect between business process documentation and working environments usually occurs because the business process documentation is not integrated into the working environment. Instead, business process documentation usually exists in separate documents or a system of documents. Further, business process documentation is usually structured according to different principles/protocols than those of the working environment. For example, the documentation may be structured as a graphical process chain, as opposed to a function structure associated with integrated application systems.

The disconnect between business process documentation and working environments has several consequences, which can significantly impact an enterprise's ability to maintain competitive advantage in the modern business landscape. One consequence is that finding information relevant to a documented business process becomes time-consuming and cumbersome. Considerable time may be required for an employee to find the necessary tools (documents, work instructions, form sheets, application systems etc.) for implementing a business process activity. Also, because the documentation often describes an entire system of processes, employees may have difficulty identifying the particular activities related to their responsibilities and also recognizing the bandwidth of alterations permitted by a process type. Additionally, the disconnect between business process documentation and working environments results in an inability to draw conclusions regarding business process implementation, since it is difficult to establish a backward reference from the actual implemented process to the documented pattern. As a result, the business process documentation is not used frequently and not fully maximized. Rather, the documentation is often used for secondary objectives, such as presentations of goods to be cleared, inspection, and training new employees. Because the business process documentation serves secondary objectives, instead of actually steering the work processes, the quality and topicality of process documentation decreases. Moreover, the enterprise fails to fully exploit the benefits of process documentation. For example, the enterprise does not use the documentation to evaluate and improve its primary business processes and, thus, forgoes opportunities to identify sources of revenue loss and optimize resource deployment.

### SUMMARY

Systems, apparatus, methods and computer-readable media consistent with embodiments of the present invention may obviate one or more of the above and/or other issues and drawbacks. Consistent with an aspect of the invention, business process documentation may be integrated with working and/or other environments.

Consistent with the present invention, a computerized method for generating a process-driven working environment may be provided. The method may comprise: identifying a business process associated with an entity; identifying resources associated with the business process; associating documentation of the business process with the identified resources; and electronically providing a working environment with access to the business process documentation and the associated resources.

Consistent with the present invention, a computerized method for implementing a business process may be provided. The method may comprise: identifying a business process associated with an entity; identifying knowledge associated with the business process; documenting the identified knowledge to generate business process documentation that describes the business process; electronically presenting the business process documentation in a workbench; and electronically providing, via the workbench, access to resources for implementing the business process described in the business process documentation.

Consistent with the present invention, a system for implementing a business process may be provided. The system may comprise: means for identifying a business process associated with an entity; means for identifying resources associated with the business process; means for associating documentation of the business process with the identified resources; and means for providing access to the business process documentation and the associated resources.

Consistent with the present invention, a computer-based environment for implementing a business process may be provided. The environment may comprise: a process design system configured to design and document a business process; a business information space including resources for implementing the business process; and a process workbench, interfacing the process design system and the business information space, operable to communicate information between the process design system and the information system, such that the documented business process is linked with the resources for implementing the business process.

Consistent with the present invention, a computer-readable medium containing instructions for controlling a computer system to perform a method may be provided. The method may comprise: identifying a business process associated with an entity; identifying resources associated with the business process; associating documentation of the business process with the identified resources; and electronically providing access to the business process documentation and the associated resources.

Consistent with the present invention, a computer-readable medium containing instructions for controlling a computer system to perform a method may be provided. The method may comprise: identifying a business process associated with an entity; identifying knowledge associated with the business process; documenting the identified knowledge to generate business process documentation that describes the business process; presenting the business process documentation in a workbench; and electronically providing, via the workbench, access to resources for implementing the business process described in the business process documentation.

The foregoing background and summary are not intended to be comprehensive, but instead serve to help artisans of ordinary skill understand implementations consistent with the present invention as set forth in the appended claims. In addition, the foregoing background and summary are not intended to provide any independent limitations on the claimed invention or equivalents thereof.

### BRIEF DESCRIPTION OF THE DRAWINGS

The accompanying drawings show features of implementations consistent with the present invention and, together with the corresponding written description, help explain principles associated with the invention. In the drawings:

FIG. 1 illustrates a flowchart of an exemplary process, consistent with the present invention;

FIG. 2 illustrates a flowchart depicting exemplary aspects of generating a business process implementation tool, consistent with the present invention;

FIG. 3 illustrates a flowchart of an exemplary method of preparing business process information, consistent with the present invention;

FIG. 4 illustrates an exemplary tree structure, consistent with the present invention;

FIG. 5 illustrates a flowchart of an exemplary method for generating and embedding business process documentation, consistent with the present invention;

FIG. 6 illustrates an exemplary HTML documentation of a business process, consistent with the present invention;

FIG. 7 illustrates exemplary overview graphic of a business process, consistent with the present invention;

FIG. 8 illustrates a detailed depiction of an exemplary business process activity, consistent with the present invention;

FIG. 9 illustrates a depiction of an exemplary business process activity and its responsible parties, consistent with the present invention;

FIG. 10 illustrates a graphic presentation of exemplary access-managed work items, consistent with the present invention;

FIG. 11 illustrates an exemplary system, consistent with the present invention;

FIG. 12 illustrates an exemplary software architecture, consistent with the present invention;

FIG. 13 illustrates an exemplary engine structure, consistent with the present invention;

FIG. 14A illustrates aspects of a data relationship, consistent with the present invention;

FIG. 14B illustrates an exemplary data structure consistent with the present invention;

FIG. 15 illustrates an exemplary environment in which embodiments of the invention may be implemented; and

FIG. 16 illustrates aspects of exemplary graphic information consistent with the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention. Other implementations and embodiments may be used and structural and procedural changes may be made without departing from the scope of present invention.

Conceptual Overview

Systems, methods and computer-readable media consistent with embodiments of the present invention may integrate business process documentation (e.g., textual descriptions of business process activities) with work environments. Embodiments of the present invention may structure a working environment associated with a business entity in such a way that maximizes the benefits of business process documentation while simultaneously minimizing the time and effort involved in implementing the documented processes. Consistent with the present invention, business process documentation may be used to form a preliminary framework structure for the business entity's working environment.

As an example, consider that Enterprise X establishes a quality auditing business process, which includes several process activities that should be executed by one or more employees. This quality auditing business process may be documented by Enterprise X to the extent that textual descriptions associated with each process activity are generated and stored within Enterprise X's infrastructure (e.g., in one or more management systems). These descriptions may be unsystematic and not associated with the systems and applications needed for implementation. Consistent with the present invention, the unsystematic knowledge associated with an established business process may be documented and integrated with employee working environments via a process implementation tool, such that the employees can efficiently execute the process activities. Aspects of the present invention may provide employees of Enterprise X with a working environment in which the auditing process is graphically depicted via a user interface and linked with various resources (e.g., system applications, documents, etc.) for implementing the process activities. The user may navigate the process depiction and access the linked resources in order to execute the auditing process.

The foregoing discussion is intended to introduce and provide initial clarity for some of the aspects associated with the present invention. Further details of the above-mentioned functionality and embodiments, as well as additional aspects, features, and embodiments of the present invention will be described below.

Business Process Implementation Tool Lifecycle

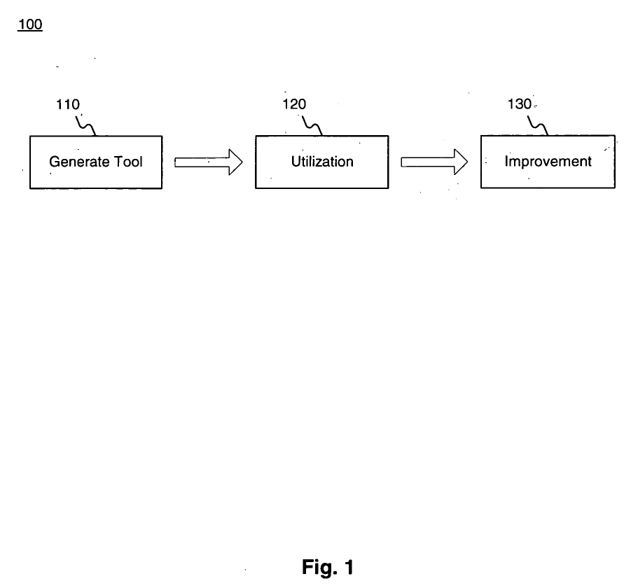

FIG. 1 illustrates a flowchart 100 of an exemplary business process implementation tool lifecycle, consistent with embodiments of the present invention. As illustrated in FIG. 1, embodiments of the present invention may provide a business process implementation tool (stage 110), enable tool utilization (stage 120), and enable tool improvement (stage 130).

Generation

Consistent with the present invention, a business process implementation tool (BPIT) may be generated (stage 110). The BPIT may provide documentations of business processes associated with a business entity and facilitate efficient implementation of those documented processes. As used herein, the term “business process” refers to any related group of activities that produce an output associated with a value-related goal. A business process “activity” may include any operation, procedure, task, process step, transaction, initiative, and/or sequence of actions performed in order to achieve the business process goal. Business process activities may be computer-performed and/or performed by one or more individuals (e.g., executives, workforce, customers, etc.). A sequence of activities that execute a specific goal or task associated with a business process may be referred to as a “work process.”

Business processes may be associated with one or more “business entities,” which may include enterprises organizations, corporations, partnerships, firms, enterprises, service providers, manufacturers, suppliers, distributors, wholesalers, retailers, educational institutions, government agencies, and the like. A business process may be developed within a single business entity and implemented either within a single business entity or across several business entities. In addition, business processes could be collaboratively developed among several business entities.

Consistent with the present invention, a BPIT may be generated for pre-established business processes associated with a business entity. Establishing a business process may include designing the business process, collecting and managing knowledge, designating responsible parties, and establishing various resources necessary for process implementation. Establishing a business process may also include generating various descriptions, such as process activity descriptions, descriptions of responsible parties, and descriptions of resources for implementing the process.

Depending on the particular business entity and business process, business process descriptions may be integrated in a business entity's management system. A “management system” refers to any system used by a business entity for managing internal activity (e.g., quality, security, etc.) A “management system” may document regulations, procedures, responsibilities, etc. for meeting objectives in a certain area. One example of a management system is a quality management system, which may document regulations, procedures, and responsibilities associated with quality assurance. By way of further example, management systems may include systems that comply with the ISO 9000:2000 international standard.

A business entity may establish business processes using various modelling tools, such as those available in the ARIS Toolset provided by IDS Scheer AG (Saarbruecken, Germany). In one example, the business processes may be described using the eEPK presentation standard in the ARIS Toolset.

Consistent with the present invention, the BPIT may serve as a “workbench” that integrates business process documentation with resources for implementing the business process, such that a user can navigate the process and efficiently execute the process using the resources. Business process “documentation” refers to a systematic representation of a business process. Such representations may include various forms of visual and audible information, such as text, graphics, symbols, audio signals, video signals, holographic images, etc. The business process “documentation” may be generated based on pre-existing knowledge, descriptions, and representations associated with a business process, such as information included in management systems and/or established by process modeling and design tools (e.g., ARIS).

A “resource” for implementing a business process refers to any application, system, or element that implements or executes an activity associated with a business process. Resources for implementing a business process may include one or more elements included in or coupled to IT infrastructures, information systems, logistics systems, financial infrastructures and accounting systems, procurement systems, operations systems, human resource systems, customer interface systems, storage networks and infrastructures, etc. Resources may include electronic documents, electronic templates from which documents can be generated, masks in application systems (e.g., in SAP R/3), Intranet information (in various forms), Internet resources, e-mails, telephone, fax, appointment planners, etc. Resources may also include and/or utilize one or more of workflow software, CRM (customer relationship management) systems, ERP (enterprise resource management) systems, EAI (enterprise application integration) tools, CIM (Computer Integrated Manufacturing) tools, SCM (Supply Chain Management) systems, customer-, supplier-, and/or internal-oriented e-Business applications, and any other business-related applications and/or intelligence.

To further illustrate the relation between business processes and resources, consider the following example. Assume a business process X includes a {Calculate Offer} activity, which must be executed by employee A. In order for employee A to carry out the activity (i.e., calculate the offer), employee A might need to access various resources, such as a price list, information in a database (e.g., addresses, product identifiers, etc.), information on a disk drive, an Intranet or the Internet. These resources may be dispersed throughout the employer's infrastructure. Generating the BPIT (stage 110) may involve documenting the business process X, including the {Calculate Offer} activity, integrating the documentation with the various resources for implementing the business process (e.g., databases, Intranet, etc.), and providing a workbench through which employee A can access and navigate the documented process and efficiently access the resources needed for implementing the {Calculate Offer} activity.

As mentioned above, the BPIT may integrate business process documentation with resources for implementing the business process and provide access to those resources. Consistent with the present invention, generating a BPIT and providing access to resources may include linking or associating business process activities with resources. As used herein, the terms “link” and “association” may be used interchangeably and refer to any qualitative or quantitative correlation. Associations may, for example, be implemented by way of software code, tags, identifiers, pointers, addresses, hyperlinks, transaction codes, etc. Associations may be leveraged by the BPIT to provide users access to resources for implementing documented business process activities.

To illustrate aspects of associating process activities with resources, consider the following example. Assume that a business process, designed and modeled in ARIS, includes an activity that requires access to an external system, such as an SAP resource. The SAP resource may be linked with the activity via a transaction code included (e.g., by ARIS) in an attribute of the activity. In this example, associating process activities with resources may involve identifying the transaction code from the activity attribute and linking the transaction code with the SAP resource. When a user selects and executes the activity using the BPIT, the BPIT may provide the user access to the SAP resource (which may include initiating a transaction) using the transaction code.

As another example, assume that a business process, designed and modeled in ARIS, includes an activity that requires access to a document located on an intranet associated with the business entity. An attribute associated with the activity may contain information identifying the document and its location. In this example, a hyperlink may be established between the process activity, which is depicted in the BPIT, and the appropriate intranet document.

As yet another example, assume that a business process, designed and modeled in ARIS, includes an activity that requires access to a document stored in database associated with the business entity. That activity may have an attribute that includes and/or specifies a template for the document and/or a resource pool (e.g., a database) from which the template or document can be retrieved. In this example, associating process activities with resources may include copying the template from the resource pool and linking the template to the activity, which may be depicted in the BPIT. In one example, the document could be linked via a hyperlink.

Utilization

Once the BPIT is generated (110), the BPIT may be utilized (120). In one embodiment, the BPIT may present in a user's working environment (e.g., a computer workstation) a “navigation structure” representing a business process documentation. The presented business process may be linked with the necessary resources for executing the process, as well with descriptions of the individual business process activities and work processes. The BPIT may allow users to navigate the process and access the documentation and resources through the navigation structure.

One or more user interfaces may be provided to facilitate utilization of the BPIT. In at least one example, a user interface may be provided in a user's working environment that facilitates access to the BPIT. Providing a user interface may involve establishing and/or configuring one or more websites maintained by one or more computer systems. The user interface may enable users to identify, access, manipulate, and view business processes, as well as access documentation and resources for implementing processes. An exemplary user interface for process implementation is descried in a concurrently filed U.S. patent application entitled “User Interface For Complex Process Implementation,” Attorney Docket No. 09268.0005-00, which is expressly incorporated herein by reference to its entirety.

Improvement

Once a generated BPIT has been utilized by a business entity, and business process instances have been generated, the BPIT may be improved (130). Improving a BPIT may involve analyzing a business process to determine whether aspects of the BPIT should be modified. Analyzing business processes may involve measuring business process performance and facilitating business process management and improvement. Measuring business process performance may include calculating one or more performance indicators, such as KPIs (key performance indicators) based on recorded instances of documented business processes. Performance indicators may include measurable and/or calculable properties of business processes and their functions (i.e., activities). Performance indicators may measure time, cost, quality of service, volume, reliability, etc. Performance indicators may be differentiated according to established or configurable dimensions, which may be based on time, location, process type, products, customers, documents, etc. Filters may also be specified for use with performance indicators.

In accordance with an aspect of the invention, performance indicators may be calculated for every process instance to measure and analyze process performance. The term “process instance” refers to a particular realization of given business process. A process instance may correspond to a business process that has actually been executed. That is, a process instance may represent an actual business activity that has occurred.

In addition, analyzing business processes may involve establishing one or more process instance independent performance indicators and dimensions, which are not calculated from process instance data, but instead from data independent of individual process instances. These indicators may be used to analyze business processes when instance-related data is unavailable.

Analyzing business processes may also include generating trend analyses, business process cycle time analyses, top/flop analyses, yield tables, quartile analyses, customer churn rates, etc. In one example, analyzing business processes may include performing multi-dimensional analyses of information obtained from the resources implementing those processes.

Consistent with the present invention, improving a BPIT (120) may involve identifying business process activities that require change. Improving a BPIT (120) may also include identifying weaknesses in links between process activities and resources for implementing those activities. In one embodiment of the present invention, identifying activity changes and weaknesses in links may be based on business process analyses.

In at least one example, improving a BPIT (120) may also include improving one or more business processes serving as the basis for the tool. Improving the business process may include changing the sequence of process activities, changing the responsibility for process activities, and/or changing the resources for implementing process activities. BPIT improvement (120) may comprise improving business processes based on information gleaned from one or more process analyses, such as one of those described above.

Exemplary Phases of BPIT Generation

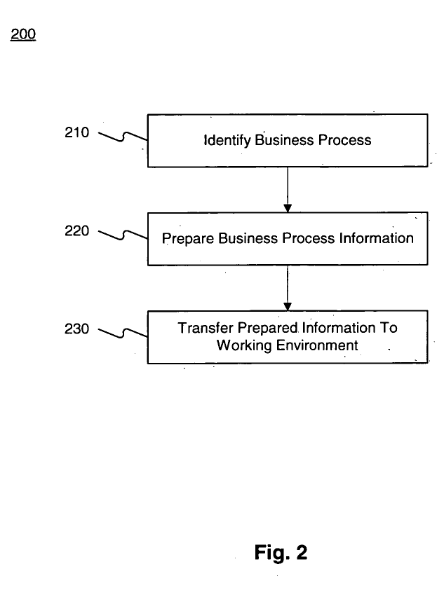

FIG. 2 illustrates a flowchart 200 depicting exemplary phases of generating a BPIT (110). As illustrated in FIG. 2, generating a BPIT (110) may comprise identifying a business process (stage 210), preparing business process information (stage 220), and transferring the prepared business process information into a working environment (stage 230).

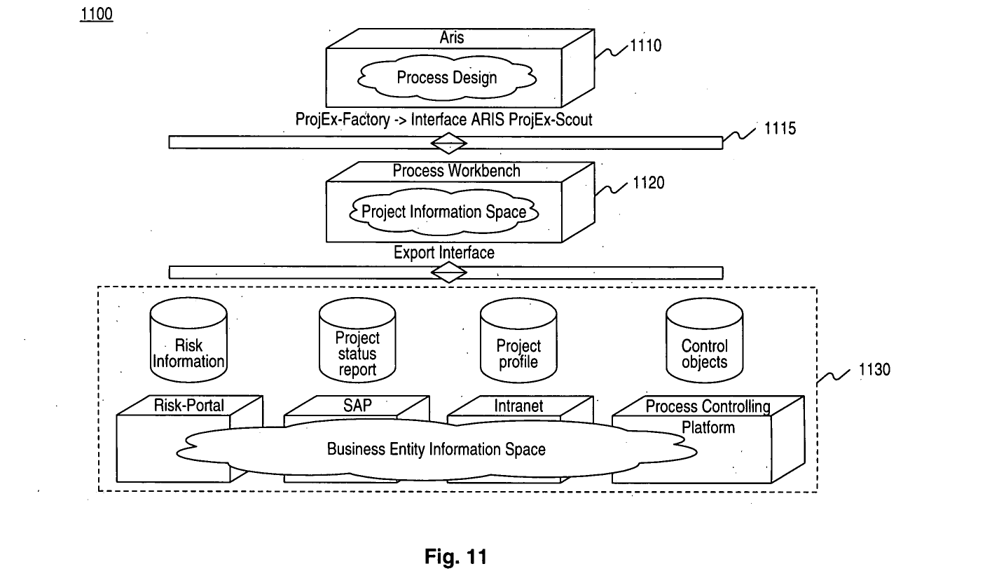

Identifying a business process (stage 210) may involve identifying an established business process associated with a particular business entity. A particular business entity may have one or more established business processes, as well as the resources for implementing those process. Identifying an established business process (stage 210) may include interfacing with a business entity's process design and modelling tools (e.g., ARIS) to identify one or more pre-established business processes. In one implementation of the present invention, this interfacing may be performed by one or more software-based modules, such as those described below in connection with FIGS. 11-15. Consistent with the present invention, identifying a business process may be performed automatically or in response to a user selection.

Once a business process is identified, business process information may be prepared (stage 220) for integration. As used herein, the term “business process information” refers to any information, including descriptions and knowledge, associated with an established business process. This “information” may be pre-established by one or more process modelling and design tools, and the information may be dispersed among a business entity's infrastructure. Preparing business process information may involve identifying the business process information from within the business entity's infrastructure and generating business process documentation based on this information. Preparing business process information (stage 220) may also involve establishing the “navigation structure” used for depicting the business process in the BPIT. In one implementation, one or more XML files may be used to establish the navigation structure.

As mentioned above, business processes may be associated with a business entity's management system(s). When a business process is established, the business process may be associated with one or more parts of a particular management system. That is, a specific portion of a management system may form or implement a business process. Preparing business process information may involve identifying one or more parts of a business entity's management system forming the identified business process, as well as resources needed to implement the process. The particular parts of a management system forming a given process may be marked (e.g., by the process modelling tool) to permit identification and selection of the business process from the entirety of the system. Preparing the business process information (stage 220) may involve interfacing with one or more management systems and identifying the elements of those management systems forming the identified business process.

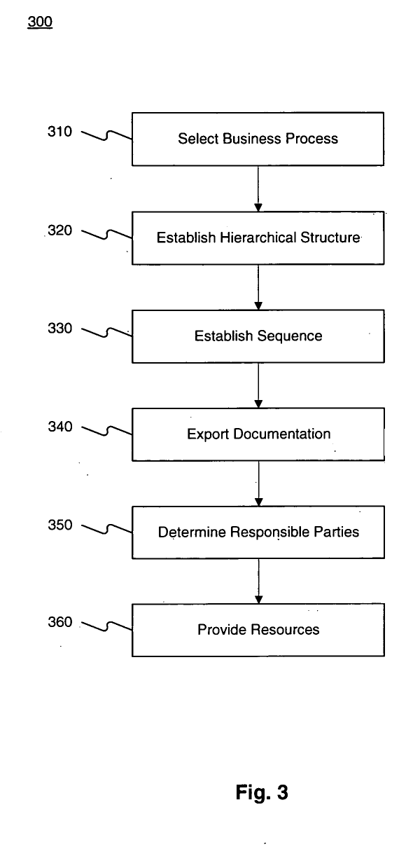

Consistent with the present invention, preparing business process information (stage 220) may involve generating “information items” based on the identified business process information and management system components. Information items may be abstractions or summaries of information available on a certain group of identifiable items. Information items may represent, for example, business process types, business activity types (i.e., an abstraction describing the type of activity, such as “sending a letter”), and elements of a business entity (e.g., departments, roles, positions, etc.). Information items may also include system design information and system documentation. Information items may be used to integrate business process documentation with resources in a business entity's working environment. In one example, information items may contain information required for integrating business process documentation and resources. Additional details, and an exemplary method of preparing process information, are described below in connection with FIG. 3.

Referring again to FIG. 2, once business process information is prepared (e.g., by generating business process documentation), the prepared information may be transferred to a working environment (stage 230) associated with the business entity. In one embodiment, the working environment may include a database with data structures that record the imported documentation and a user interface providing the interaction possibilities with this information for the user. In one example, the working environment may include Microsoft Access XP. Various relational databases and user interfaces (e.g., Web interfaces) may, however, be included in a working environment.

Consistent with the present invention, transferring the prepared business process information (stage 230) may involve generating one or more “action items.” Action items may be abstractions or summaries of process information and resources. In at least one example, action items may be executable or include executable information. Action items may represent one or more activities in a given business process, and they may include a specific set of features, such as issues associated with them, documents, planning information etc. Action items may also carry specific functionality, depending on the semantics of the particular process activity.

Action items may inherit information from information items and collect specific information required for executing business process activities. For example, action items may inherit information from the information items regarding a particular template to be used for an activity, and the action item may also contain information associated with the specific document generated from the template.

In one implementation, transferring the prepared business process information (stage 230) may include at least one of the following three phases: (1) establishing a structure, (2) associating activities with resources, and (3) establishing planning elements.

Establishing a structure (phase 1) may involve establishing a depiction (e.g., the navigation structure) for the business process. The depiction may be presented in the BPIT. The structure may be established based on the structure information generated in the preparing phase (see, e.g., stage 220; FIG. 2). In one example, all of the information for setting up the system structure may be obtained from an XML file generated during the preparing phase. Establishing a structure may include importing the XML file and sequentially setting-up the system structure. Each item of the structure may be set-up according to a hierarchical structure established during the preparing phase (stage 220).

Consistent with the present invention, resources for implementing the business process may be determined and/or compiled and associated or linked with business process activities (phase 2). In one implementation of the present invention, links may be established between structure items and descriptions of business process activities. For example, the structure items may be configured to “remember” specific description pages, and those pages may be transferred into a target folder from their generation context. Links may also be established between structure items and graphics information representing process overviews or details. Again, the graphics may be transferred into a target folder from their generation context.

Links may also be established between structure items and the work items. The structure items may save the names of forms permitting access to the functions of work items. In addition, links may be established between structure items and templates belonging to the items. The templates may be transferred into a target folder from their source folder where internally managed tools are involved. The BPIT may ensure that the templates are only available at the work step (and possibly all superior work steps) to which they were originally allocated (at the design level).

In addition, links may be established between business process activities or work processes and one or more resources for implementing those activities/processes. Transferring the prepared business process information (stage 230) may involve determining and compiling the appropriate resources associated with a business process and associating business process activities (which may be structured in a menu) with the compiled resources. The appropriate resources may be determined via the process modeling and design tool (e.g., ARIS). For example, each activity may include an attribute that identifies the appropriate resource. Associating process activities with resources (phase 2), may include linking transaction codes, establishing hyperlinks, copying templates from resource pools and linking the templates to activities, etc.

Consistent with the present invention, transferring the prepared business process information (230) may additionally involve establishing planning elements (phase 3). A planning element may be associated with an action item (which may represent a process activity). Planning elements may include data structures (containers) for the planning and runtime information needed to execute process activities. Non-limiting examples of information contained in planning elements include planned start and end dates for activities, actual start and end dates, status of activity execution information, responsible parties, actual work, planned work, etc. Establishing planning elements may involve establishing empty data structures for the appropriate planning and runtime information. The information may then be imported or inserted in the data structures from action items during business process instancing.

Details of Preparing Business Process Information

FIG. 3 illustrates a flowchart of an exemplary method of preparing business process information (stage 210). As illustrated in FIG. 3, preparing business process information may comprise selecting the business process from the management system (stage 310), establishing a hierarchical structure (stage 320), establishing a sequence of business process activities (stage 330), exporting the business process documentation (stage 340), determining responsible parties (stage 350), and determining and providing resources (stage 360). The particular order of these stages is partially necessary and partially arbitrary. For example, before an evaluation stage may be performed (e.g., stage 350), it should be determined what parts of the overall system are to be evaluated (e.g., stage 310). It may be irrelevant, however, whether responsibilities are evaluated (stage 350) before resources (stage 360).

As described above, a business process may be part of business entity's management system, with various parts of the system marked to identify the business process. Selecting the business process information from the management system (stage 310) may involve identifying all of the elements of the management system, as well as other resources, forming a particular business process. This identification may be performed via one or more software and/or hardware modules, such as those described below in connection with FIGS. 11-15.

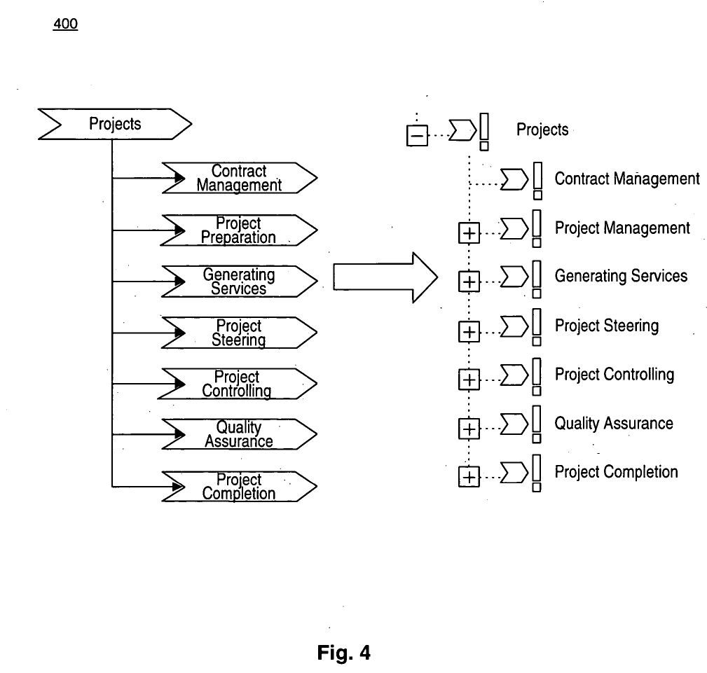

Once a business process is selected and the business process information is identified, a hierarchical structure may be established (stag 320). This may involve establishing one or more object levels into which business processes and process activities may be arranged. The broadest object level may be Level 1. Level 2 may include objects that are directly inferior to Level 1 objects. Additional levels may be established, and the number of levels may vary depending on the particular business process or business entity. Establishing the hierarchical structure may involve establishing a navigation (e.g., tree) structure. Inferiority relationships may be illustrated by corresponding spatial shifts in the navigation structure. An exemplary tree structure 400 is illustrated in FIG. 4. As shown in the example of FIG. 4, a “Projects” object may be superior to a “Contract Management” object, and this relationship may be portrayed by a spatial shift. The “Projects” object may represent one or more business process activities or even an entire business process. The “Contract Management” object may represent one or more process activities subordinate to the “Projects” activity/process. Additional objects (not shown) may be inferior to the “Contract Management” object.

Consistent with the present invention, establishing a hierarchical structure (stage 320) may involve establishing varying hierarchies depending on the parties to whom the process documentation is directed. For example, one structure may be established for mail clerks, while another structure is established for corporate management.

Establishing a hierarchical structure (320) may also involve structuring free sub-processes. Free sub-processes include sequences of process activities in a hierarchical structure that are designed at runtime and that may be used at different steps. Structuring free sub-processes may involve defining a hierarchical structure for free sub-processes, defining the sequences of activities for each hierarchical level, and providing information and tools for executing the sequences.

As further illustrated in FIG. 3, preparing business process information (stage 210) may include establishing a sequence of business process activities (stage 330) for the selected business process. Depending on the particular business process, business process activities may have a logical relationship to each other. For example, activity A may be a prerequisite for activity B, because activity A generates information required for carrying out activity B or activity B is the test step for activity A. When such logical relationships exist, it may be necessary for business activities to follow a specific sequence.

Establishing a sequence of business process activities (stage 330) may involve analysing a business process to determine whether or not the business process activities are logically related. In one implementation, determining whether activities are logically related may include analyzing a graphical representation of the business process (included in the business process information) and searching for indications of logical relationships. Searching for indications may include, for example, identifying markers or arrows linking business process activities. Once any logical relationships are determined, establishing a sequence (stage 330) may involve establishing a sequence that corresponds to the determined logical relations.

In at least one embodiment, establishing a sequence of business process activities (stage 330) may involve evaluating numbering information associated with activities and mapping that numbering information to a logical sequence. For example, establishing a sequence of activities may include mapping the logical sequence A1→A2→A3 to the numbering information 10→20→30, where A1=10, A2=20, and A3=30. The numbering information could be pre-established, for example, by the process modeling and design tool(s).

Once a business process is selected from the management system and the business process activities are identified and sequenced, business process information (e.g., textual descriptions of process activities) may be exported (stage 340) to the BPIT for integration. Consistent with the present invention, process information may be transferred to the BPIT in various ways. For example, process information may be transferred to the BPIT externally and/or embedded in the BPIT.

When the information is externally transferred, the BPIT manages access addresses for various business process information elements. The access addresses may identify locations of process information within the business entity's infrastructure. Access addresses may include various identifying elements, such as numerical values, textual strings, symbols, etc. Access addresses could include IP addresses, filenames, directory names, server names, etc. When the BPIT is used, the locations of the process information are accessed via the access addresses and the information is provided to the BPIT in its original context.

Process information may also be embedded in the BPIT. If the process information is embedded, the process information is exported from the original context, transformed into business process documentation, and supplied for a designated period of use. The BPIT may manage access addresses associated with the documentation. With embedding, however, these access addresses may be the addresses of prepared documentation and not related to the original business process information in its original context.

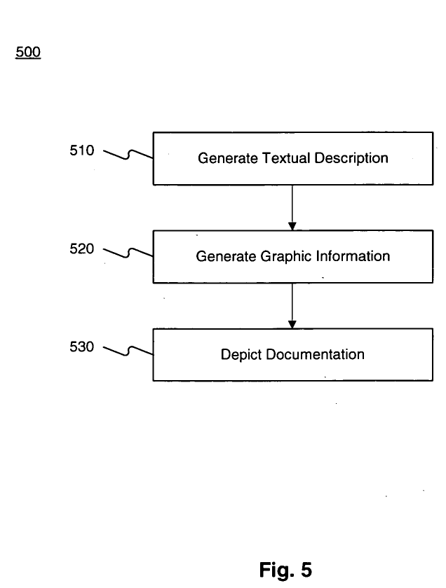

FIG. 5 illustrates a flowchart of an exemplary method for generating and embedding business process documentation, which may be part of exporting business process information (stage 340). As illustrated in FIG. 5, generating and embedding business process documentation may involve generating textual descriptions (stage 510), generating graphic information (stage 520), and depicting the documentation in the workbench (stage 530).

Generating textual descriptions (stage 510) may include generating descriptions of goals, conditions, results, etc. associated with a given business process activity or work process. Textual descriptions may be generated for one or more activities or work processes included in a given business process.

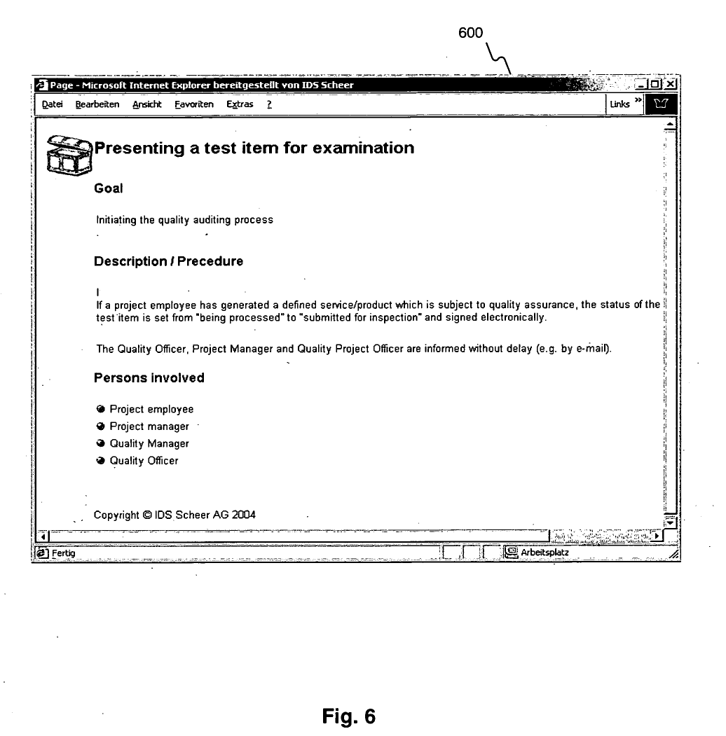

Consistent with the present invention textual descriptions may be prepared in various manners. One exemplary format is the Rich Text Format or Microsoft Word format. These formats may be particularly suitable for depicting longer continuous text. In one implementation, textual descriptions may be generated using HTML. Generating textual descriptions may include generating an HTML page for each business process activity included in a given business process. Each HTML page may contain at least the name of the activity and/or an instruction for executing the activity. Other standard information can also be provided in the HTML pages, such as goals, results, reference numbers etc. associated with process activities. The particular information included in the HTML pages may vary depending on the business' process and the design, and the particular information included in the HTML pages may be altered and/or selected during page generation. The information included in the HTML pages may comply with a pre-determined structure and may form that structure. An exemplary HTML page 600 is illustrated in FIG. 6. As illustrated in the example of FIG. 6, the information may be in the following structure: Name<Text of name of activity>→Goal<Text describing the goal>→Description/Procedure<Instructions>→Persons involved<Roles involved in the activity>.

The information available on HTML pages may be specified during the design phase. The BPIT may be configured to collate this information and allocate the information to various process activities. This information may be in the form of attributes (information carriers). As the information in the HTML page has a structure, several information carriers (attributes) and a depiction rule indicate what information carrier refers to what information category (e.g., Attribute 1->Goal, Attribute 2->Description, etc.). Various modelling tools, such as the ARIS Toolset, permitting management of these information categories in relation to process activities may be leveraged to generate the HTML pages.

When collecting the information for HTML page generating, not all information must be available in text form. For example, the people involved may be depicted as separate graphic symbols. In addition, attribute identifiers in the design may not be identical to those in the page prepared (e.g., “Description/Definition”->instead of “Description/Procedure”). One example of selecting attributes is represented by the “Type” attribute. The type attribute may not be transformed to text but may be evaluated to identify the kind of object that is used. For example, the type “organizational unit” (as an attribute) can be represented as “responsibility for an activity” in the BPIT, and the type “function” can be represented as an activity.

In one implementation, generating HTML pages may involve obtaining information from one or more databases using unambiguous identifiers (GUIDs) associated with the process activities. These GUIDs may be established by the modelling tool that designed the process to facilitate information retrieval. The retrieved information may then be exported as an XML file, which may be named based on the particular GUID(s). The HTML file generated from the XML file may inherit this name. This naming convention permits simple connection between representation of the process activity in the menu tree and the HTML page, which may be loaded when selecting the activity in the workbench. One possible method of depicting the XML transformation of text could be, for example:

<?xml version=‘1.0’ encoding=‘ISO-8859-1’?>
<!DOCTYPE Page SYSTEM ‘page.dtd’.>
<?xml-stylesheet Type=‘Text/xsl’ href=‘page.xsl’?>
<Page>
<kind>workpackage</kind>
<Headline>Presenting test item for examination</Headline>
<Sections>
<Title>Goal</Title>
<Text>Initiating the quality auditing process</Text>
</Sections>
<Sections>
<Title>Description/Procedure</Title>
<Text>If a project employee has generated a defined
product which is subject to quality assurance, the
status of the test item is changed from &quot;being
processed&quot; to &quot;submitted for
inspection&quot; and signed electronically.</Text>
<Text>The Quality Officer, Project Manager and Quality Project
Officer are informed without delay (e.g.
by e-mail).</Text>
</Sections>
<Sections>
<Title>Persons involved</Title>
<Aufzaehlung>QPV (Consulting)</Aufzaehlung>
<Aufzaehlung>Quality Officer</Aufzaehlung>
<Aufzaehlung>Project Employee</Aufzaehlung>
<Aufzaehlung>Project Manager</Aufzaehlung>
</Sections
</Page>

Referring again to FIG. 5, generating and embedding business process documentation may involve generating graphic information (stage 520). In one embodiment, the graphic information may be generated from representation already established by the business process modeling tool (e.g., ARIS). In such an embodiment, generating graphic information may include selecting the representations from the overall context so as to prepare the graphic information based on the respective process activity (selection) and to depict the graphic information in a format making minimum requirements on the technical environment (graphic formatting). The graphic information may be located in one or more files linked to the process activity, showing as a graphical representation the whole process from which the activity is a part or showing the environment of the process activity (such as application systems, responsible roles and input or output documents of the activity).

Consistent with the present invention, various types of information may be presented in graphical form to a user. One type of information is “overview” knowledge. Overview knowledge includes information as to which process activities are included in a business process, who performs/ed a process activity, when activities are performed, etc. In addition to overview knowledge, “detailed” knowledge may be presented. Detailed knowledge may include information as what roles are involved in the activities and how, what working substances are available, what resources (e.g., application systems) support the activity, what result is generated by an activity, etc. Uniform graphic representation of these types of information may allow users to efficiently navigate a business process and focus in on pertinent information.

To generate an “overview” graphic, the work process in which each activity is embedded may be identified. An image of the work process may then be generated independent of the device (e.g., in wmf or emf format) and as a file. The information item representing the particular activity is then given the name of the file with the overview graphic as an additional attribute.

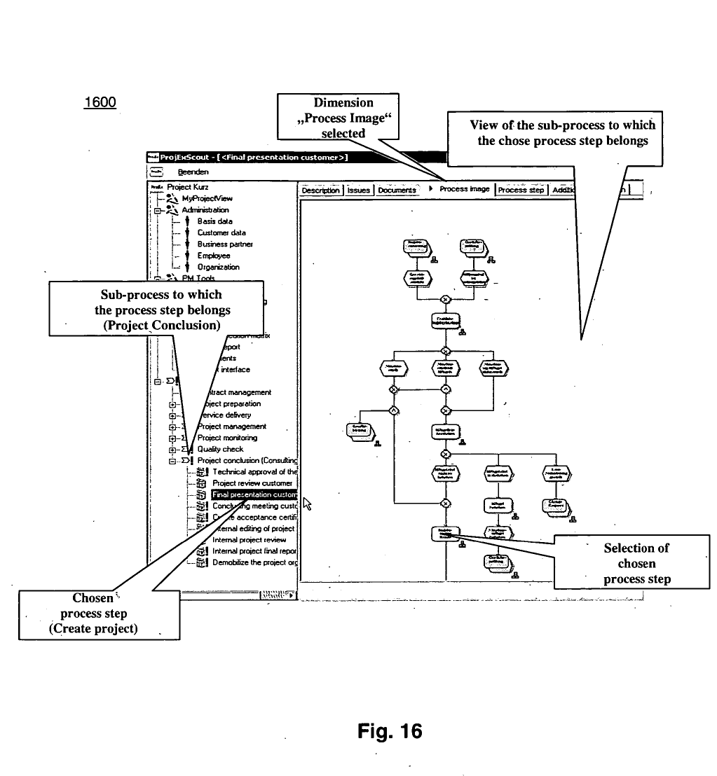

A “detailed” graphic may be generated using representations of business process already established by process modelling tools. If representations are not available, and the information exists only as text, a detailed graphic within the modelling tool may be generated automatically first as an interim step. Further steps may parallel those for generating overview graphics. Exemplary graphic information is illustrated in screen shot 1600 of FIG. 16.

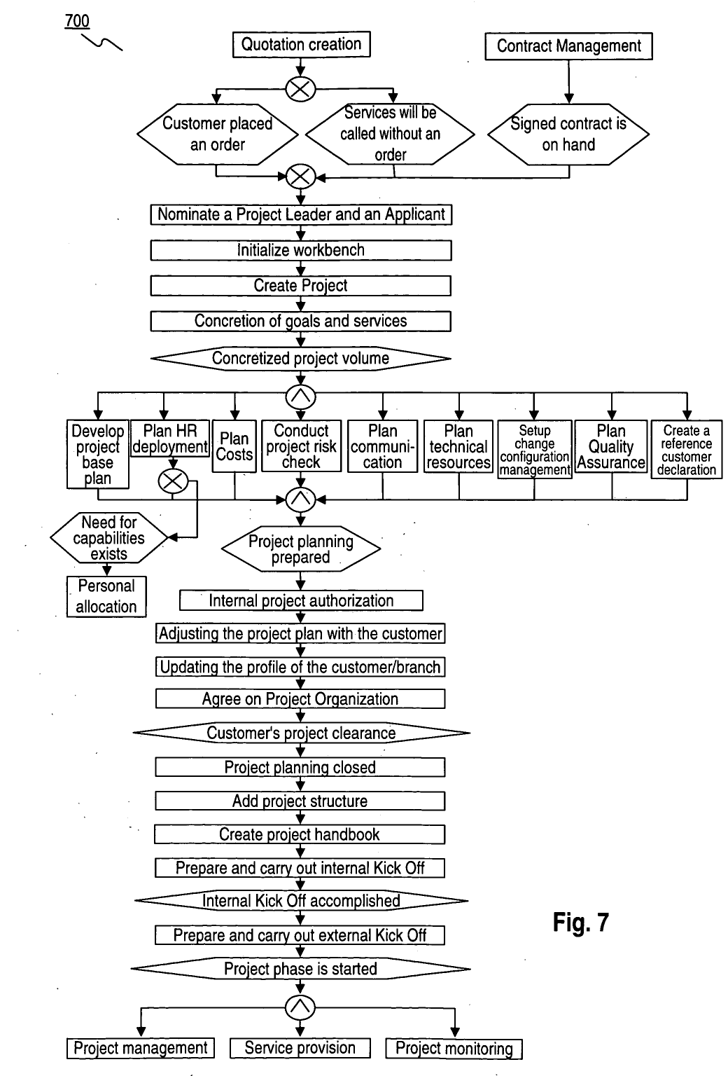

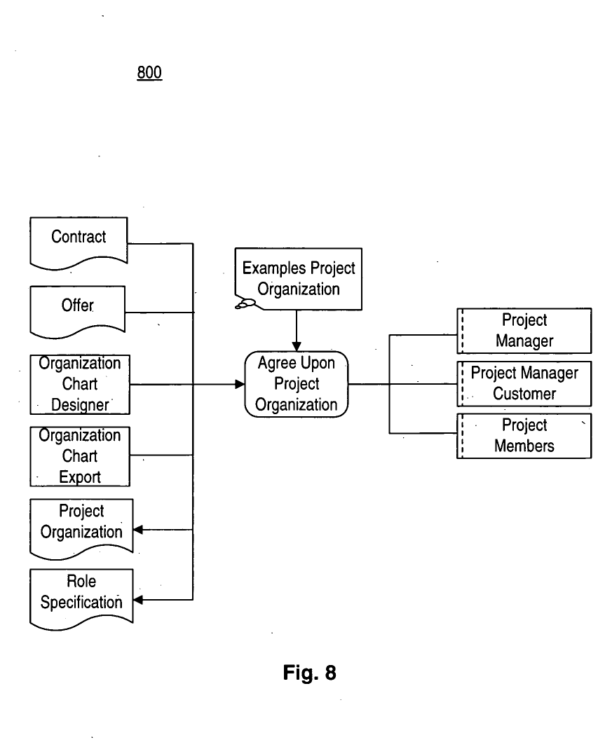

FIG. 7 illustrates a graphic 700 depicting an overview of an exemplary business process. In the example of FIG. 7, the exemplary business process is “Project Preparation.” FIG. 8 illustrates a graphic 800 providing a more detailed view of an exemplary business process activity. In the example of FIG. 8, the exemplary business process activity is “Agree on project organization,” which is one activity of the exemplary business process of FIG. 7. As illustrated in FIG. 8, responsibilities, documents, and measures of the business process activity may be depicted in graphic 800.

Referring again to FIG. 5, once business process documentation (e.g., text and graphics) is generated, the documentation may be depicted in the workbench or BPIT (stage 530). Via import into the workbench (see 230), the process activities and graphic files are put into relation (i.e., synchronized) with each other. Overview graphics and detailed graphics may both be available for each activity in a business process. In one example, the overview graphic is initially presented. Detailed view may then be added as needed or in response to user selections. In addition, users may toggle between different views. Depicting documentation in the workbench may involve generating one or more vector graphics (e.g., Windows Metafile or Enhanced Metafile format), which can be modified prior to depiction in the main memory. For example, the character string {Project Leader) can be searched and then replaced by the appropriate name which is known at the level of the specific process.

Although FIG. 5 makes reference to textual and graphic information, business process documentation may include various other forms of information, such as symbols, audio signals, video signals, holographic images, etc.

Referring back to FIG. 3, responsible parties associated with the business entity (e.g., employees) may be determined (stage 360). Consistent with the present invention, individuals may be involved with a particular process activity in a variety of ways. For example, an individual may carry out or execute a given activity. An individual (e.g., a manager) may also be responsible for ensuring that an activity is carried out or monitoring an activity. Generally, a given individual will either generate information associated with a business process activity or require information associated with a given activity, or both.

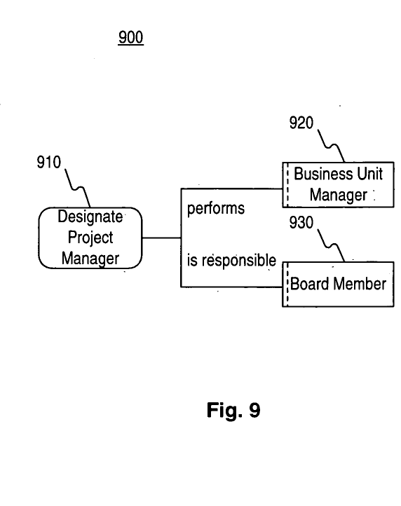

Determining responsible parties (stage 360) may include typifying individuals associated with business process activities and generating depiction of those typifications. Individuals may be typified based on responsibilities, roles, expertise, etc. in relation to business process activities. Individuals become abstract but, the knowledge, responsibilities and roles of all characterised by this particular type remain concrete. For purposes of illustration, FIG. 9 is an exemplary depiction 900 of a business process activity 910 and its responsible parties (920, 930). As illustrated, the business process activity (Designate Project Manager} may be depicted, along with a performing party type {Business Unit Manager} and a responsible party type {Board Manager}. Other types of depictions may also be used, such as positioning the type of person topologically “near” the business activity, in a separate column beside it, as a marking etc.

Consistent with embodiments of the present invention, information items representing business process activities may contain data identifying the type of individual associated with a process activity and the relation of that type to the activity. In one example, various types of restrictions may be placed on individual types, which may be controlled by selectable variants. An “open” variant may allow all individuals authorized to access the system to access information without restriction and/or modify all information. An “open-function” variant may allow information associated with a business process activity to be accessed by only those who can execute the process activity. The business process may be visible in the menu structure by only those possible executors.

In addition, a “restrictive” variant may provide information access to an individual only when that individual has been specifically allocated responsibility for a particular business process activity. For example, an individual may obtain access to information associated with a {Draw up Offer} business activity only when that individual is designated as the party responsible to execute the {Draw up Offer} business activity. With a “restrictive” variant, being a possible executor of an activity may not be sufficient to obtain access to information associated with that activity.

Consistent with embodiments of the present invention, open variants may be extended. Extending the open variants may involve imposing a restricted-executor view of the business process, even when it is not necessary to restrict the actions, in order to reduce the overall process to a small number of activities.

A person logging in to the system can choose the role or combination of roles with which they log in. Only those activities are displayed for which the person is authorized to act. Selection of roles can be switched at any time. In this case, the process tree is immediately set-up again with the new selection volume.

Consistent with the present invention, variants may be subsets of the whole set of actions. In one implementation, each item may include an attribute, such as {is depicted} as a Boolean value. The set-up of the process tree may select and present all items by which the {is depicted} flag is true. By changing the role or the set of roles, the {is depicted} flag may changed for the activities where the role or the set of roles are involved. When a new role changes the {is depicted} flag, the tree may be reloaded and may show the role dependent view.

Referring again to FIG. 3, preparing business process information (stage 210) may include providing resources (stage 360) for implementing the business process. As explained above, resources may include electronic documents, electronic templates, masks in application systems (e.g., in SAP R/3), Intranet information, etc. The resources associated with a particular business process may be dispersed amorphously throughout a business entity's infrastructure independent of business processes. Providing resources (stage 360) may involve identifying the particular resources associated with a business process, e.g., by analyzing the identified business process information (which may be pre-established by process design and modelling tools). Providing resources may involve facilitating access to the identified resources. Access to a resource may be linked to the technical medium providing the information. For example, in the case of application systems, a client must be linked to a server. Providing access to identified resources may involve establishing or accessing folders, browsers, and various other communication media.

In one embodiment, providing resources (stage 360) for implementing the business process may include generating one or more work items. Work items may include collections of information required for a business activity and collectively form a logical unit (i.e., can no longer be taken apart without essential parts missing for use). Work items may include the information needed to access resources for executing an activity. Various work items can be required for a given process activity. For example, in order to perform an {Order Calculation} activity, information from a central order system (order number, information on access to the system, etc.) may be required. A price list (which could be available as a centralized list on a network directory) may also be required. In addition, a spreadsheet as a template holding the specific data may be required. One or more work items may be generated for the {Order Calculation} activity in order to provide access to these resources. In the order calculation example, a first work item may include information need to access an application system, such as system type, addresses, program entry codes, document identifiers, transaction codes, etc. For access to the price list, a second work item may include information identifying the list and its location. For access to the spreadsheet, a third work item may include information for accessing, loading, and storing a spreadsheet template.

Consistent with embodiments of the present invention, various types of work items may be generated. For example, “access-managed” work items, “resource-supported” work items, and “workbench-managed” work items. Access-managed work items may supply basic information or access to information. For example, access managed work items may provide Intranet addresses. The BPIT (i.e., workbench) may manage the identification and access data for this type of item.

Resource-supported work items may include work items that change, with functionality of the data manipulation embedded in a particular resource, such as an application system. The resource, therefore, supplies the data structures and action possibilities for this type of work item. For resource-supported work items, the workbench must manage the identification, resource, and access data, and possibly the information flowing between such systems.

Workbench-supported work items may include work items that are the object of a change experienced via a process activity but that are separate from the resources managing their data. For these items, a data “cover” may be established permitting management as if they were being managed in the resources. The workbench may depict the action framework for this type of item and also manage the associated data. These items may fully controlled by the workbench.

A particular business process may include one or more of the above-identified types of work items. The varying work item types may be processed and managed in varying ways. Work items that merely provide information without being subject to any transformations (access-managed work items) can be embedded in the BPIT or externally accessed. A work item is embedded when it becomes part of the workbench, i.e., when the physical item itself is managed rather than an access method for the item. When a work item is embedded, a copy of the item is made and this copy is installed along with the workbench—either as a file or as a component in a database. Access management for embedded work items may include copying the item from its actual source path into the workbench's source path, and also replacing the original source path with the new source path defined by the workbench.

Access to work items is external when the workbench only knows the access path to the item, but where the work item itself is not a part of the system. In this case, the work item is loaded when the corresponding business process activity is carried out.

Either or both types of access (embedding and external access) may be employed, depending on the particular business process and resources. For example, when changes are to be excluded for a stable work environment during the process (e.g., an order was calculated using a price list valid at time t1 and an order to be performed at t2 requires access to the price list as it existed at t1 rather than at t2), embedding work items may be appropriate. Embedding may also be appropriate when access to system components is not possible, not always possible, or not efficient. In addition, embedding may be appropriate when the workbench manages authorizations to work items (e.g., where the price list may not be viewed by everyone, but rather only by those employees in the role of processing orders).

External access, however, may be appropriate when this type of access is always possible. External access may also be appropriate when role-based management of access restrictions is already achieved by source systems. Additionally, external access may be appropriate when access to the latest version of a resource (e.g., a price list) is desired/required.

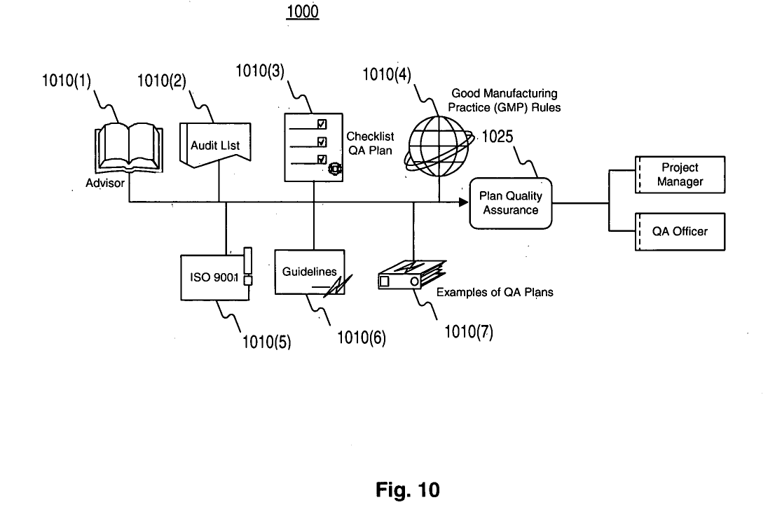

Consistent with embodiments of the present invention, the various meanings of work items in the application context may be identified to assist users in terms of orientation and finding relevant information. This may be accomplished via a variety of procedures, such as using unambiguous symbols and text identifiers. In one example, work items may be identified during the BPIT design phase and presented such that their context is clear. One exemplary graphic presentation 1000 of access-managed work items 1010(1)-1010(7) associated with a particular process activity (e.g., 1025) is illustrated in FIG. 10.

FIGS. 1-10 are consistent with exemplary implementations of the present invention. Further, the sequence of events described in connection with FIGS. 1-10 is exemplary and not intended to be limiting. Other steps may therefore be used, and even with the methods depicted in FIGS. 1-10, the particular order of events may vary without departing from the scope of the present invention. Further, the illustrated steps may overlap and/or may exist in fewer steps. Moreover, certain steps may not be present and additional steps may be implemented in the illustrated methods. The illustrated steps may also be modified without departing from the scope of the present invention and its embodiments.

The illustrated methods and procedures may be implemented via one or more hardware, software, and/or firmware components. In one implementation, the functionality described above may be implemented in one or more software modules running on one or more data processing systems. In addition, various neural networks, decision trees, artificial intelligence engines, and/or other logic-based apparatus or processes may be employed for implementing functionality consistent with the present invention. The illustrated methods and procedures are not inherently related to any particular apparatus or system and may be implemented in conjunction with any suitable combination of components. One exemplary system consistent with the present invention is detailed below.

Exemplary System

FIG. 11 illustrates an exemplary system 1100, consistent with embodiments of the present invention. As illustrated in FIG. 11, system 1100 may include a process design module 1110, a process workbench 1120, and a business entity information space 1130. System 1100 may, in at least one example, include functional logic to implement one or more of the methods described in connection with FIGS. 1-10.

Process design module 1110 may be implemented by one or more software, hardware, and/or firmware components and may leverage one or more logical components, processes, algorithms, systems, applications, and/or networks. Process design module 1110 may establish, design, and document business processes associated with a business entity. Process design module 1110 may include one or more modeling tools, such as the AR IS Toolset provide by IDS Scheer AG (Saarbruecken, Germany).

Process workbench 1120 may include one or more software, hardware, and/or firmware components and may leverage one or more logical components, processes, algorithms, systems, applications, and/or networks. Process workbench 1120 may include functionality associated with the BPIT discussed above. Process workbench 1120 may provide access to process information at process runtime. Process workbench 1120 may export data to various applications that administer the logical information space of a business entity. In addition, process workbench 1120 may serve as an input interface for basic business entity data, such as employee data, project data, financial data, etc.

Process workbench 1120 may interface process design module 1110 via a process interface 1115. Process interface 1115 may be part of process workbench 1120 and/or process design module 1110. Process interface 1115 may generate XML files that are imported by process workbench 1120 and may build an application framework for business processes.

Business entity information space 1130 may include one or more software, hardware, and/or firmware components and may leverage one or more logical components, processes, algorithms, systems, applications, and/or networks. Information space 1130 may include various data associated with a business entity. In certain embodiments of the invention, business entity information space 1130 may include one or more knowledge bases associated with a business entity. As used herein, the term “knowledge base” refers to any repository, resource, facility, or lexicon, operable to maintain and access information, such as numeric information, textual information, audible information, graphical information, etc. The knowledge bases may include one or more structured data archives distributed among one or more network-based data processing systems. In one example, a knowledge base may include one or more relational databases and management systems (e.g., Oracle databases, DB2, MS SQL, etc.). In addition, a knowledge base may leverage one or more elements from a storage area network (SAN). A particular knowledge base may be multidimensional in that it may organize data hierarchically and across several dimensions. In one implementation, a given knowledge base may be configured to provide data warehousing functions for a business entity.

Business entity information space 1130 may also include one or more resources for implementing business processes. For example, business entity information space 1130 may include application systems, IT infrastructure components, documents, knowledge bases, etc.

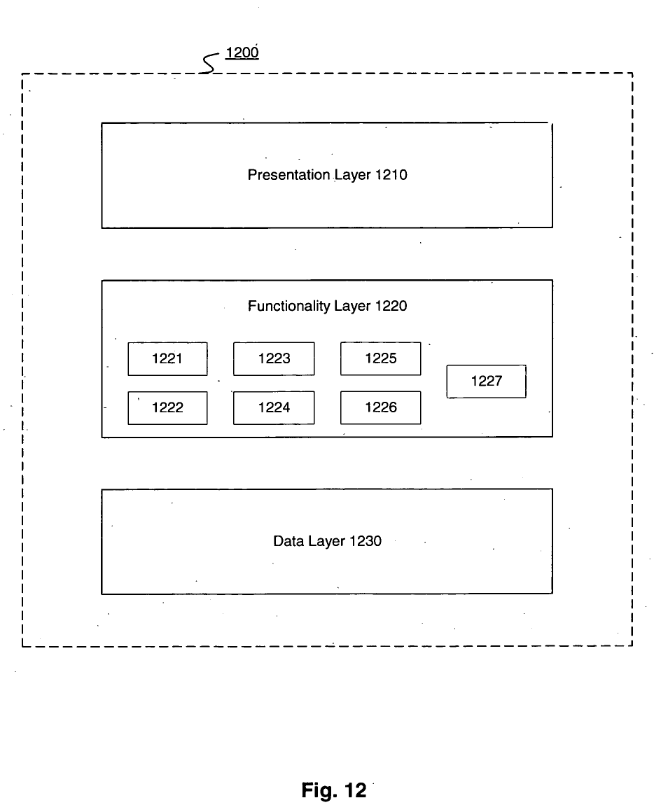

FIG. 12 illustrates an exemplary software architecture 1200 that may employed for implementing process workbench 1120. As illustrated in FIG. 12, architecture 1200 may include a presentation layer 1210, a functionality layer 1220, and a data layer 1230. In one embodiment, software architecture 1200 may be embodied in one or more modules implemented in one or more programming languages, such as eXtendable Markup Language (XML), HTML, HTML with JavaScript, C/C++, Java, etc. Software architecture 1200 may be embedded on one or more memories and executed by one or more processors associated with a business entity.

Presentation layer 1210 may provide one or more user interfaces. Presentation layer 1210 may provide user forms, reports, and other data structure-independent information. Presentation layer 1210 may serve as a gateway or front end (e.g., a communications portal) through which one or more users can interact with functions of software architecture 1200. In one embodiment, presentation layer 1210 may include and/or leverage one or more Graphical User Interfaces (GUIs), as well as one or more intranet websites, extranet websites, and Internet websites. In certain implementations, presentation layer 1210 may be distributed among a plurality of clients in a client/server architecture.

Functionality layer 1220 may include one or more data objects (implemented as class modules or classes) and one or more engines that provide complex functionality. Functionality layer 1220 may allow engines to access (read/write) data in the data layer 1230 via the data classes. In certain embodiments, functionality layer 1220 may perform one or more authorization functions and/or plausibility checks.

As used herein, the term “engine” refers to a collection of complex functionality of the same type. An engine may be implemented as a class or module that provides specific functionality in all contexts on the same way. As illustrated in FIG. 12, functionality layer 1220 may include the following exemplary engines: an import engine 1221, a framework builder engine 1222, a language table builder engine 1223, a framework engine 1224, an authorization engine 1225, a document engine 1226, and an office automation engine 1227. The illustrated engines are exemplary only, and additional or fewer engines may be implemented within functionality layer 1220.

Import engine 1221 may receive and analyze import data and deliver the data to framework builder engine 1222. Import engine 1221 may, in certain configurations, be operable to receive information in various formats, including XML and CSV (comma-separated values) or other flat file formats. Framework builder engine 1222 may receive data from import engine 1220 and generate data objects and connections required for building a business process framework. In response to a user selecting a particular business process (e.g., from within ARIS), import engine 1221 and framework builder 1222 may import the corresponding information and generate data objects. Language table builder engine 1223 may allow business processes to be imported in various languages and may build one or more language string values.

Framework engine 1224 may serve as the primary engine during runtime. Framework engine 1224 may generate and present navigation trees and links, as well as detailed views corresponding to selected business process activities.

Authorization engine 1225 may determine and manage user privileges and provide user specific content. Document engine 1226 may administer documents that are part of the business process information space. Office automation engine 1227 may implement a data interface between different types of documents.

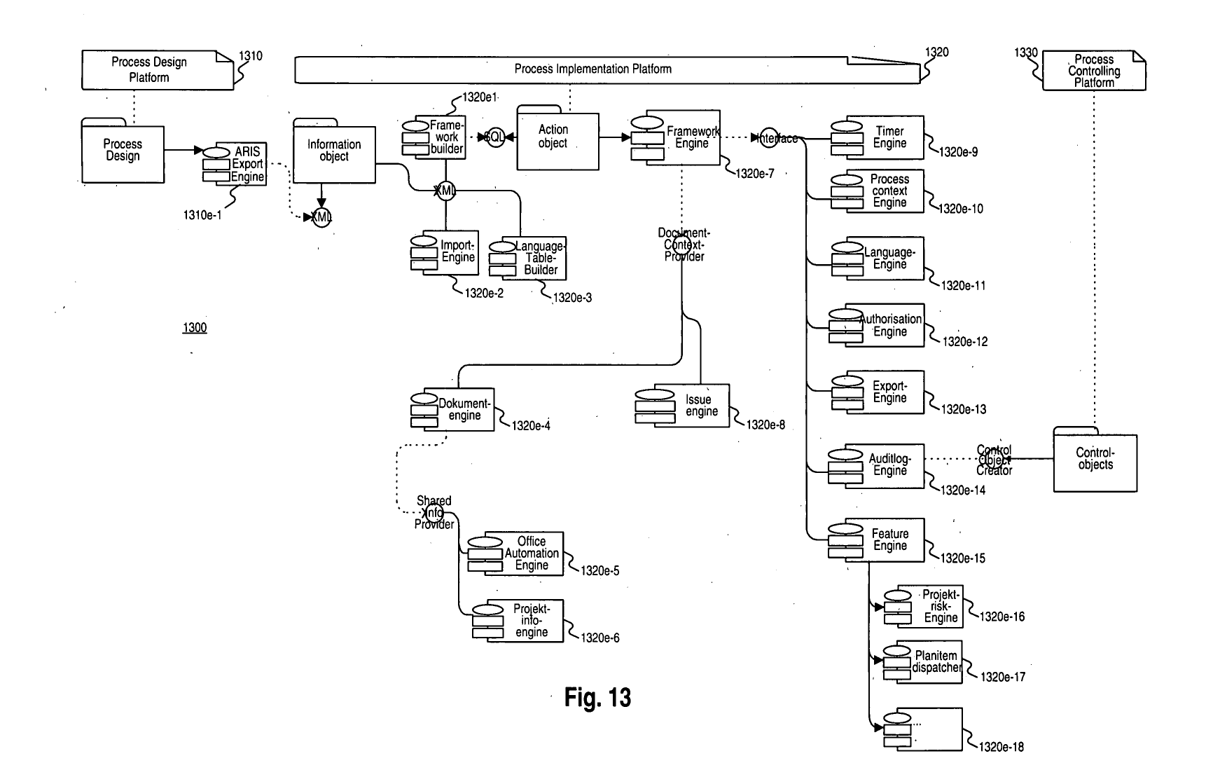

An exemplary engine structure 1300 is implemented as part of functionality layer 1220 is depicted in FIG. 13. As illustrated in FIG. 13, structure 1300 may include a process design platform 1310, a process implementation platform 1320, and a process control platform 1330. Each of platforms 1310, 1320, and 1330 may include one or more engines for performing one or more tasks.

Process design platform 1310 may include an export engine 1310e-1 for exporting process designs from various business process modeling tools, such as ARIS. Export engine 1310e-1 may transform graphical process designs in an export structure that is apt to be implemented in the framework (example: a set of XML-Files with structure information and depictions).

Process implementation platform 1320 may include various engines (e.g., 1320e-1 through 1320e-18) for building frameworks and facilitating process implementation. Authorization engine 1320e-12, for example, may grant or deny access to database objects depending on user privileges. Export engine 1320e-13 may encapsulate various or all export functionality, such as choosing export directories, building filenames, determining export file layouts/formats, identifying bookmarks that should be filled, etc. Auditlog engine 1320e-14 may create audits and error entries. Engine 1320e-14 may also provide functionality to configure log scopes, start or stop logging, and provide control objects for the controlling platform. In addition, feature engine 1320e-15 may provide various workbench functionality (e.g., user forms and data structures) to support user activity.

Process control platform 1330 may provide control functionality associated with business process implementation. Process control platform 1330 may collect and control information associated with business process execution. Process control platform 330 may also provide functionality to perform various analyses, such as key performance indicator analyses. In one implementation, process control platform 1330 may embody business process performance analysis functionality associated with the ARIS Toolset.

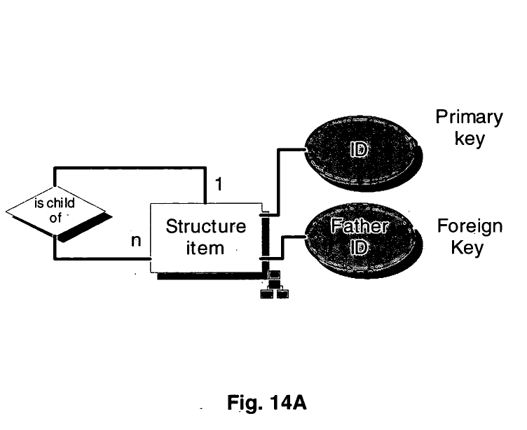

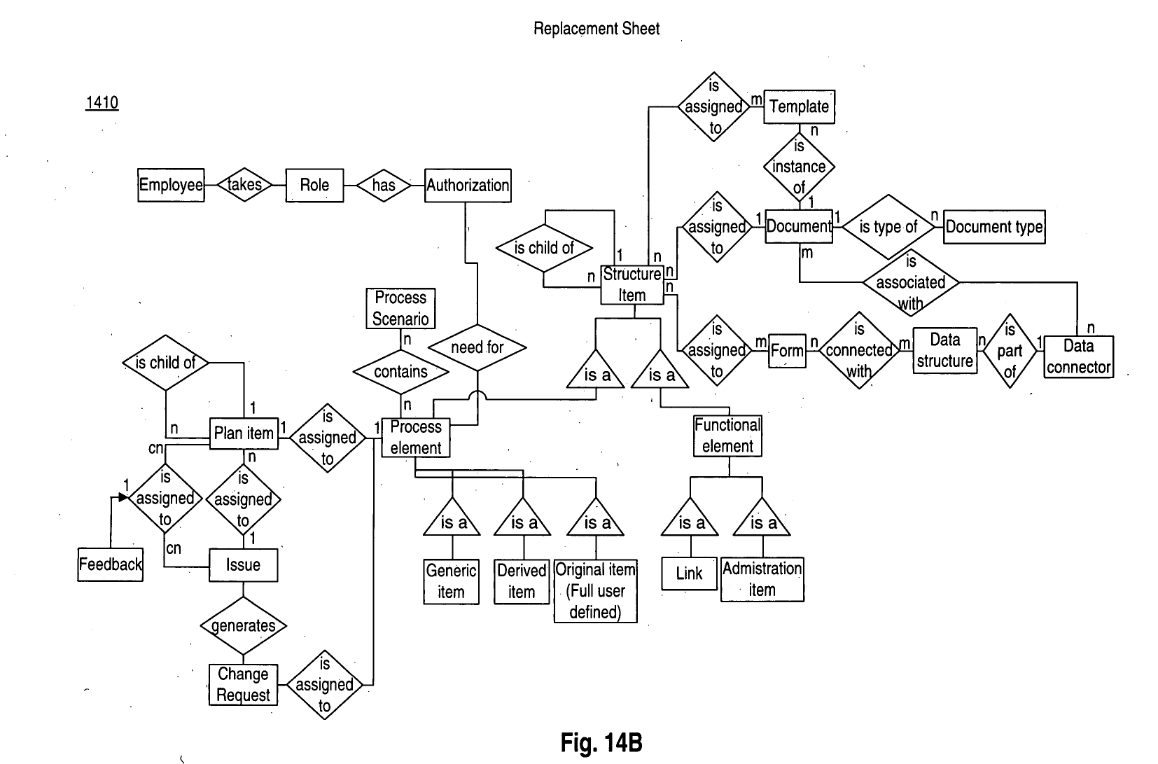

Referring back to FIG. 12, data layer 1230 may include information for building the navigation structure presented by the BPIT. Information included in data layer 1230 may be assigned to the structure elements the build the navigation structure. Various techniques may be employed for building hierarchical and relations data structures for the navigation structure and assigning relevant data to the structure elements. In one implementation, father-child relationships may be used to build the structure. In such an implementation, the child may contain a primary key of his father as a data field (i.e., foreign key). In this fashion, each item “knows” its father and each father is able to access all of its children by selecting the elements that have its own key ad the foreign key. FIG. 14A illustrates an exemplary father-child relation consistent with the present invention.

Each data element may include any number of children or no children at all. That is, each data element may have a 1:n relationship. To build the data structure, a virtual “first” data element may be selected. The structure may take form by obtaining the first element's children and then obtaining their respective children, recursively. FIG. 14B illustrates an exemplary data structure 1410, which may be generated using father-child relationships, consistent with the present invention.

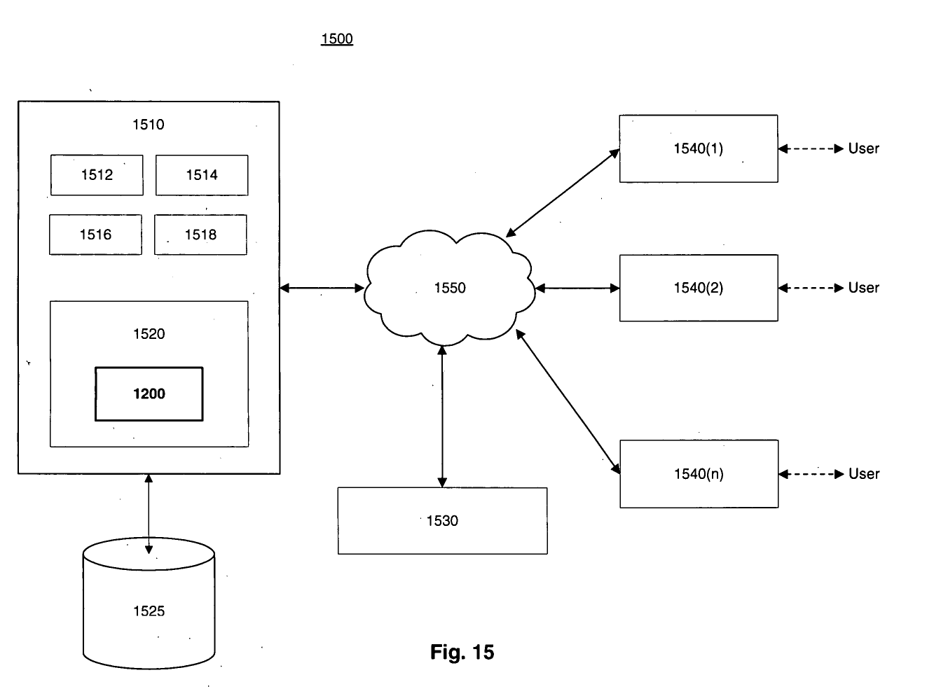

FIG. 15 illustrates an exemplary environment 1500 compatible with the present invention and in which methods and systems consistent with the present invention may be implemented. As illustrated in FIG. 15, environment 1500 may include a data processing system 1510, repository 1525, a management system 1530, one or more access points 1540(1)-1540(n), and a network 1550. The number of components in environment 1500 is not limited to what is shown and other variations in the number of arrangements of components are possible. For example, repository 1520 and/or management system 1530 could be implemented as part of one or more data processing systems 1510 and/or access points 1540. In addition, one or more access points 1540 could be integrated with or implemented as part of data processing system 1510. For example, a user could interact with data processing system 1510 directly, without a separate access point 1540.

Data processing system 1510 may represent any system, device, or apparatus suitable for processing information and implementing functionality consistent with the present invention. Data processing system 1510 may include a general-purpose computer, server, personal computer (e.g., a desktop), workstation, and other hardware-based processing systems known in the art. In certain implementations, data processing system 1510 may include mobile computing devices (e.g., laptops, PDAs, a Blackberry™, an Ergo Audrey™, etc.), mobile communications devices (e.g., cell phones), or other structures that enable users to remotely access information. Consistent with the present invention, one or more of aspects of system 1100 may be implemented in data processing system 1510. For example, as depicted in FIG. 15, software architecture 1200 may run on data processing system 1510. Although a single data processing system 1510 is depicted, environment 1500 may comprise any number of geographically-dispersed data processing systems, each similar or different in structure and capability. Aspects of system 1100, including software architecture 1200, may therefore be distributed among one or more geographically-dispersed data processing systems 1510.

Data processing system 1510 may include various components, such as a network interface 1512, a processor 1514, I/O devices 1516, a display 1518, and a storage 1520. A system bus (not illustrated) may interconnect such components. The illustrated components are exemplary only, and data processing system 1510 may comprise additional components, fewer components, and/or varying components.

Network interface 1512 may be any appropriate mechanism and/or module for facilitating communication with a network, such as network 1550. Network interface 1512 may include one or more network cards and/or data and communication ports.

Processor 1514 may be configured for routing information among components and devices and for executing instructions from one or more memories. Although FIG. 15 illustrates a single processor, data processing system 1510 may include a plurality of general-purpose processors and/or special purpose processors (e.g., ASICS). Processor 1514 may be implemented, for example, using a Pentium™ processor commercially available from Intel Corporation.

I/O devices 1516 may include components such as keyboard, a mouse, a pointing device, and/or a touch screen. I/O devices 1516 may also include audio- or video-capture devices. In addition, I/O devices 1516 may include one or more data reading devices and/or input ports.

Data processing system 1510 may present information and interfaces (e.g., GUIs) via display 1518. Display 1518 may be configured to display text, images, or any other type of information. In certain configurations, display 1518 may present information by way of a cathode ray tube, liquid crystal, light-emitting diode, gas plasma, or other type of display mechanism. Display 1518 may additionally or alternatively be configured to audibly present information. Display 1518 may be used in conjunction with I/O devices 1516 for facilitating user interaction with data processing system 1510.

Storage 1520 may provide mass storage and/or cache memory for data processing system 1510. Storage 1520 may be implemented using a variety of suitable components or subsystems. Storage 1520 may include a random access memory, a read-only memory, magnetic and optical storage elements, organic storage elements, audio disks, and video disks. In certain configurations, storage 1520 may include or leverage one or more programmable, erasable and/or re-useable storage components, such as EPROM (erasable programmable read-only memory) and EEPROM (electrically erasable programmable read-only memory). Storage 1520 may also include or leverage constantly-powered nonvolatile memory operable to be erased and programmed in blocks, such as flash memory (i.e., flash RAM). Although a single storage module is shown, any number of modules may be included in data processing system 1510, and each may be configured for performing distinct functions.

Storage 1520 may include program code for various applications, an operating system, an application-programming interface, application routines, and/or other executable instructions. Storage 1520 may also include program code and information for communications (e.g., TCP/IP communications), kernel and device drivers, and configuration information. In one example, software architecture 1200 may be implemented in storage 1520.

As illustrated in FIG. 15, environment 1500 may include a repository 1525, which may be coupled to data processing system 1510 and/or network 1550. Repository 1525 may provide a knowledge base, and data processing system 1510 may leverage repository 1525 to perform various functions. Repository 1525 may be embodied by various components, systems, networks, or programs and may include one or more software, hardware, and/or firmware elements. Repository 1525 may represent one or more structured data archives distributed among one or more network-based data processing systems. Repository 1525 may be multidimensional in that it may organize data hierarchically and across several dimensions. Repository 1525 may include and/or leverage one or more schemas (e.g., file systems) for managing stored information. In certain configurations, repository 1525 may leverage one or more elements from a storage area network (SAN). Repository 1525 may include one or more relational databases and systems (e.g., Oracle databases, DB2, MS SQL, etc.), distributed databases, object-oriented programming databases, and/or any other mechanism, device, or structure for managing, accessing, and updating an aggregation of data.

Although depicted as coupled to data processing system 1540 in FIG. 15, repository 1525 may be distributed among various systems and/or may be included in or coupled to network 1550.

Management system 1530 may include any combination or hardware, software, and/or firmware components used by a business entity for managing internal activity (e.g., quality, security, etc.) Management system 1530 may also represent a paradigm, and perhaps information, for managing internal activity. Management system 1530 may document regulations, procedures, responsibilities, etc. for meeting objectives in a certain area (e.g., quality management). Management system 1530 may, in one implementation, be constructed according to the ISO 9000:2000 international standard.

Network 1550 in FIG. 15 may be any appropriate structure for enabling communication between two or more nodes or locations. Network 1550 may include a shared, public, or private data network and encompass a wide area or local area. Network 1550 may also include a broadband digital network. Network 1550 may employ communication protocols such as User Datagram Protocol (UDP), Transmission Control and Internet Protocol (TCP/IP), Asynchronous Transfer Mode (ATM), SONET, Ethernet, or any other compilation of procedures for controlling communications among network locations. Further, in certain embodiments, network 1550 may leverage voice-over Internet Protocol (“VoIP”) technology. Moreover, network 1550 may include optical fiber, Fibre Channel, SCSI, and/or iSCSI technology and devices.

As illustrated in FIG. 15, one or more access points 1540(1)-1540(n) may be coupled to network 1550. An access point 1540 may include any system, device, or apparatus suitable for allowing a user to access elements of environment 1500 (such as network 1550) and send and receive information to/from those elements. Access points 1540 may include various systems, devices, and apparatus, such as desktop computers, workstations, kiosks or “dumb” terminals, mobile computing devices (e.g., laptops, PDAs, a Blackberry™, an Ergo Audrey™, etc.), mobile communications devices (e.g., cell phones), etc. A plurality of geographically-dispersed access points, each similar or different in structure and capability, may be included in environment 1500.

In one configuration, access points 1540 may include components similar to those included in data processing system 1510. Access points 1540 may, however, be structurally different from data processing system 1510 and may have varying or additional components. For example, access points 1540 may be configured with less storage capacity and processing power than data processing system 1510 in order to reduce cost and size. In addition, access points 1540 may include user interface components, such as displays, input devices, etc., while data processing system 1510 may lack such components.

For purposes of explanation only, certain aspects of the present invention are described herein with reference to the discrete functional blocks illustrated in FIGS. 11-15. The functionality of the illustrated blocks may, however, overlap and/or may be present in any number of elements and modules. Elements of each system may, depending on the implementation, lack certain illustrated components and/or contain, or be coupled to, additional or varying components not shown. Further, all or part of the functionality of the illustrated blocks may co-exist or be distributed among several geographically dispersed locations. Moreover, embodiments, features, aspects and principles of the present invention may be implemented in various environments and are not limited to the illustrated environments and architectures.

The foregoing description of possible implementations consistent with the present invention does not represent a comprehensive list of all such implementations or all variations of the implementations described. The description of only some implementations should not be construed as an intent to exclude other implementations. Artisans will understand how to implement the invention in the appended claims in many other ways, using equivalents and alternatives that do not depart from the scope of the following claims.

1. A computerized method for generating a process-driven working environment, comprising:
identifying a business process associated with an entity;
identifying resources associated with the business process;
associating documentation of the business process with the identified resources; and
electronically providing a working environment with access to the business process documentation and the associated resources.

2. The method of claim 1, wherein identifying resources includes identifying one or more elements of a management system.

3. The method of claim 1, wherein identifying resources includes identifying at least one of an application system, a database, a document, and an individual.

4. The method of claim 1, wherein associating documentation of the business process with identified resources comprises establishing a hyperlink.

5. The method of claim 1, wherein associating documentation of the business process with identified resources comprises:
identifying activities included in the business process;
identifying information associated with the activities; and
generating the business process documentation using the activities and information.

6. The method of claim 1, wherein associating documentation of the business process with identified resources comprises:
identifying activities included in the business process;
documenting the identified activities; and
linking the documented activities with the identified resources.

7. The method of claim 6, wherein providing access to the business process documentation and the associated resources comprises:
presenting the documented activities in the working environment; and
providing access to the linked resources in the working environment.

8. The method of claim 1, wherein providing access to the business process documentation and the associated resources comprises providing a user interface in the working environment.

9. The method of claim 1, wherein providing access to the business process documentation and the associated resources comprises:
generating a navigation structure representing the business process; and
providing in the working environment access to the navigation structure.

10. The method of claim 9, wherein generating the navigation structure representing the business process comprises generating a graphical overview of the business process.

11. The method of claim 1, further comprising:
evaluating at least one implementation of the business process;
altering the documentation based on the evaluation; and
updating the working environment to reflect the altering.

12. The method of claim 1, further comprising:
evaluating at least one implementation of the business process;
altering at least one association between the documentation and the identified resources; and
updating the working environment to reflect the altering.

13. The method of claim 12, wherein altering at least one association comprises:
identifying an association between the business process and a first identified resource; and
changing the identified association so that the business process is associated with a second identified resource different from the first resource.

14. The method of claim 1, further comprising designing a business process prior to identifying the business process.

15. A computerized method for implementing a business process, comprising:
identifying a business process associated with an entity;
identifying knowledge associated with the business process;
documenting the identified knowledge to generate business process documentation that describes the business process;
electronically presenting the business process documentation in a workbench; and
electronically providing, via the workbench, access to resources for implementing the business process described in the business process documentation.

16. The method of claim 15, wherein identifying a business process includes identifying one or more elements of a management system.

17. The method of claim 15, wherein electronically presenting the business process documentation comprises:
establishing a navigation structure for the documentation; and
electronically presenting the navigation structure in the workbench.

18. The method of claim 17, wherein electronically presenting the navigation structure comprises electronically presenting a graphical overview of the business process.

19. The method of claim 15, wherein electronically providing access to resources includes electronically providing access to at least one of an application system, a database, a document, and an individual.

20. The method of claim 15, wherein electronically providing access to resources includes associating the business process documentation with the resources.

21. The method of claim 20, wherein associating the business process documentation with the resources include establishing a hyperlink.

22. A system for implementing a business process, the system comprising:
means for identifying a business process associated with an entity;
means for identifying resources associated with the business process;
means for associating documentation of the business process with the identified resources; and
means for providing access to the business process documentation and the associated resources.

23. A computer-based environment for implementing a business process, the environment comprising:
a process design system configured to design and document a business process;
a business information space including resources for implementing the business process; and
a process workbench, interfacing the process design system and the business information space, operable to communicate information between the process design system and the information system, such that the documented business process is linked with the resources for implementing the business process.

24. The environment of claim 23, wherein the process workbench comprises:
a presentation module that provides at least one user interface;
a functionality module configured to:
import data from the presentation module including data associated with the business process design,
build a framework for representing the business process design, and
present the framework and provide access to the business information space; and
a data module for storing the framework.

25. The environment of claim 23, wherein the process design system includes at least one business process modeling tool operable to design and manage business processes.

26. The environment of claim 23, wherein the business information space includes at least one database storing information associated with the business process.

27. The environment of claim 23, wherein the process design system and process workbench are included in at least one data processing system.

28. The environment of claim 27, wherein the process workbench provides at least one user interface through an access point coupled to the data processing system by a network, and wherein users access the process workbench via the access point.

29. A computer-readable medium containing instructions for controlling a computer system to perform a method, the computer system having a processor for executing the instructions, the method comprising:
identifying a business process associated with an entity;
identifying resources associated with the business process;
associating documentation of the business process with the identified resources; and
electronically providing access to the business process documentation and the associated resources.

30. A computer-readable medium containing instructions for controlling a computer system to perform a method, the computer system having a processor for executing the instructions, the method comprising:
identifying a business process associated with an entity;
identifying knowledge associated with the business process;
documenting the identified knowledge to generate business process documentation that describes the business process;
presenting the business process documentation in a workbench; and
electronically providing, via the workbench, access to resources for implementing the business process described in the business process documentation.
